(19) United States
(12) Patent Application Publication
(10) Pub. No.: US 2007/0203705 A1
(43) Pub. Date: Aug. 30, 2007

(54) Database storing syllables and sound units for use in text to speech synthesis system

(76) Inventors: Inci Ozkaragoz, Torrance, CA (US); Benjamin Ao, Torrance, CA (US); William Arthur, San Juan Capistrano, CA (US)

Correspondence Address: MURAMATSU & ASSOCIATES, Suite 310, 114 Pacifica, Irvine, CA, 92618, US

(21) Appl. No.: 11/647,826

(22) Filed: Dec. 30, 2006

Related U.S. Application Data
(60) Provisional application No. 60/755,409, filed on Dec. 30, 2005.

(51) Int. Cl. G10L 13/08

(52) U.S. Cl. 704/260

(57) ABSTRACT

In embodiments the present invention includes a method for populating a text to speech synthesis database. This method can include the steps of defining a set of phonetic symbols, wherein each symbol is a single alphabetic character representing a separate sound, representing a syllable by at least one phonetic symbol of the set of phonetic symbols to form a phonetic representation of the syllable, recording a verbal expression of the syllable using the phonetic representation, indexing the recording of the verbal expression of the syllable to a description of the recording, and storing the indexed recording of the verbal expression of the syllable in a database.

This application claims the benefit of U.S. Provisional Patent Applications Ser. No. 60/755,409 filed Dec. 30, 2005, entitled “DATABASE STORING SYLLABLES AND SOUND UNITS FOR USE IN TEXT TO SPEECH SYNTHESIS SYSTEM” by Ozkaragoz, et al., which is hereby incorporated by reference herein for all purposes.

### FIELD OF THE INVENTION

The technology disclosed by this application is related to a text to speech synthesis. More specifically in embodiments to database storing of syllables and sound units for text to speech synthesis using a concatenative processes.

### BACKGROUND ART

Text-to-speech synthesis technology gives machines the ability to convert arbitrary text into audible speech, with the goal of being able to provide textual information to people via voice messages. Key target text to speech synthesis applications in communications include: voice rendering of text-based messages such as email or fax as part of a unified messaging solution, as well as voice rendering of visual/text information (e.g., web pages). In the more general case, text to speech synthesis systems provide voice output for all kinds of information stored in databases (e.g., phone numbers, addresses, vehicle navigation information) and information services (e.g., restaurant locations and menus, movie guides, etc.). Ultimately, given an acceptable level of speech quality, text to speech synthesis systems could also be used for reading books (i.e., Talking Books) and for voice access to large information stores such as encyclopedias, reference books, law volumes, etc.

In certain applications such as mobile or portable devices, the text-to-speech systems have been limited by both the processing power and data storage capacity of the devices. As such, a need exists for text to speech device and/or method which provides an acceptable level while minimizing the processing and data storage needed.

### SUMMARY OF THE INVENTION

In embodiments the present invention includes a method for populating a text to speech synthesis database. This method can include the steps of defining a set of phonetic symbols, wherein each symbol is a single alphabetic character representing a separate sound, representing a syllable by at least one phonetic symbol of the set of phonetic symbols to form a phonetic representation of the syllable, recording a verbal expression of the syllable using the phonetic representation, indexing the recording of the verbal expression of the syllable to a description of the recording, and storing the indexed recording of the verbal expression of the syllable in a database.

Depending on the embodiment, the set of phonetic symbols can include a relatively small number of symbols. In some cases the set is less than 50 symbols and in other the set is 39 symbols. The set of phonetic symbols can include at least one symbol indicating a level of stress. In some cases the phonetic symbols include four symbols indicating levels of stress including an unstressed symbol, a primary stress symbol, a phrasal stress symbol, and a secondary stress symbol.

The phonetic representation of a syllable can be at least two phonetic symbols. Each individual sound represented by an alphabetic character of the symbol set is a single phoneme.

When recording a verbal expression of the syllable using the phonetic representation the linguistic context of the syllable can also be recorded. This linguistic context can define whether the syllable is bounded by a vowel or a consonant. The linguistic context can also be recorded to the database and indexed to the recorded verbal expression. Also, storing the indexed recording of the verbal expression of the syllable can be done in a database contained in a vehicle navigation device.

In some embodiments the method for populating a text to speech synthesis database can also include the steps of obtaining text of a word having the syllable, providing from the database the recording of the verbal expression of the syllable, transmitting the recording of the verbal expression over an audio speaker.

### BRIEF DESCRIPTION OF THE DRAWINGS

FIGS. 1A-D show flow charts according to at least one embodiment of the present invention.

FIG. 2 shows a flow chart according to at least one embodiment of the present invention.

FIG. 3 shows a flowchart according to at least one embodiment of the present invention.

### DETAILED DESCRIPTION OF THE INVENTION

The text to speech synthesis system of the present invention incorporates a database which stores syllables and supersyllables as well as sound units created by a voice recording tool and a voice analysis tool. This application also discloses the features involved in the database for storing the syllables and sound units, the voice recording tool for recording speech sounds produced by a voice talent, and the voice analysis tool for marking-up and analyzing syllables in the phrases recorded by the voice recording tool.

A text to speech synthesis system in the conventional technology utilizes diphones, semi diphones, and phonemes as concatenative units. In contrast, one of the essential features of the text to speech synthesis system that has been developed by the inventors of this application resides in the fact the syllable and supersyllable are used as concatenative units. Syllables are combinations of phonemes.

A text to speech synthesis system using the phoneme as the concatenative unit tends to involve acoustic mismatches between vowels and consonants within the syllable. For example, it could concatenate the two phonemes “b” and “u” to produce the word “boo”. However, unless specifically designed not to do so, it could conceivably concatenate with “b” a vowel “u” that originally was recorded with a preceding “d”. Since the second formant of the naturally produced “bu” is very different from the second formant of the naturally produced “du”, the synthesized output of “bu” would not sound exactly like the original naturally produced “bu”. The text to speech synthesis system of the present invention avoids this problem since the system uses the syllable as the concatenative unit. The text to speech synthesis system would produce the synthesized syllable “bu” just as it was recorded since it was never split into phonemes. Consequently, it is possible to avoid mismatches within syllables.

The concatenative unit which is used in the present invention text to speech (TTS) synthesis system is based on a syllable-in-context construct. Since any English word can be split into syllables consisting of a vowel nucleus and adjacent consonants, the notion of the syllable as the basic concatenative unit has advantages. One of the greatest advantages of making the syllable the basic concatenative unit is that the acoustic characteristics of most consonant-vowel transitions are preserved. That is, context-conditioned acoustic changes to consonants are automatically present to a great extent when the syllable is chosen as the basic unit. However, due to the fact that the syllable inventory for English is very large and sufficient computational storage and processing capabilities must be available.

Although using the syllable as the basic concatenative unit reduces the number of acoustic mismatches between vowels and consonants within the syllable, it does not address the problem of treating coarticulation mismatches across syllable boundaries. This type of syllable boundary coarticulation can be just as important as within syllable coarticulation.

Here, the syllable coarticulation means as follows. For example, individual sounds like “b” “a” and “t” are encoded or squashed together into the syllable-sized unit “bat”. When a speaker produces this syllable, his vocal tract starts in the shape characteristic of a “b”. However, the speaker does not maintain this articulatory configuration, but instead moves his tongue, lips, etc. towards the positions that would be attained to produce the sound of “a”. The speaker never fully attains these positions because he starts towards the articulatory configuration characteristic of “t” before he reaches the steady state (isolated or sustained) “a” vowel. The articulatory gestures that would be characteristic of each isolated sound are never attained. Instead the articulatory gestures are melded together into a composite, characteristic of the syllable. There is no way of separating with absolute certainty the “b” articulatory gestures from the “a” gestures. Consequently, the “b” and the “a” are said to be coarticulated.

Syllable-in-Context Synthesis

Due to the problem of syllable boundary coarticulation stated above, the TTS System of embodiments of the present invention has stored in its TTS database every possible English syllable, and if the syllable is bounded by a vowel on at least one side, its possible linguistic context is encoded as well. Because of storage limitations, providing the linguistic context for each syllable was limited to syllables whose boundaries consisted of vowels, but not consonants. This is because, relatively speaking, more linguistic coloring occurs across vocalic boundaries than across consonantal boundaries. For example, the syllable “ba” would have linguistic context encoded for the vowel “a”, but not for the consonant “b”. The syllable-in-context construct of using the English syllable as the basic concatenative unit along with its very large inventory of linguistic context provides for a smooth synthetic output. The syllable context information is encoded for syllables beginning or ending with a vowel.

Supersyllables

As mentioned above, due to storage limitations, in embodiments only syllables with vocalic boundaries could have their linguistic context recorded and stored in a TTS database. This leaves open the possibility of coarticulation mismatches across consonantal syllabic boundaries. This is one reason why the concept of the supersyllable was created; it allows certain syllables to include more than one vowel nucleus when the syllables involve consonants that are particularly prone to coloring their adjacent linguistic context. For example, when the consonant “r” is crucially followed by an unstressed vowel, as in “terrace” shown below, the concatenative unit then includes both vowels on which the “r” hinges. Since two vowel nuclei are included in this concatenative unit, it's referred to as a supersyllable and is not divisible within the system. (Note: Unstressed vowels are indicated by the tilde ˜. The phrasal stress is indicated by the asterisk *.)
e.g. TERRACE tE*rx˜s}

Another example of a supersyllable is if two vowels appear consecutively and one is unstressed as in “spi˜a*” shown below. Typically, the unit would be split into two syllables. The decision to classify two consecutive vowels, in which one is unstressed, into a supersyllable is that there is heavy linguistic coloring between the two vowels; as such there is no exact dividing line between the vowels acoustically.
e.g. CASPIANA ka“¦spi˜a*¦nx˜}
   VCV Structures

Since there is no objective criteria for assigning consonants to a particular vowel nucleus in certain ambiguous cases such as “letter”, embodiments of the TTS System of the present invention delineates VCV structures into V¦CV. Thus, “letter” for example would be phonetically divided into “le” and “tter”, rather than “lett” and “er”, in such embodiments of the system.

Because embodiments of the TTS system of the present invention use the syllable and supersyllable as the concatenative units, the system can avoid coarticulation mismatches across syllable boundaries as noted above. When syllables are concatenated with other syllables, the linguistic context of the syllables (if ending or starting with a vowel) is taken into account in order to avoid mismatches across syllable boundaries. For example, when the syllable “pA*” is concatenated with a following syllable that starts with a “p”, as in POPULAR pA*¦plu˜A˜r], the syllable “pA*” must be selected from a class of “pA*” that all were followed by a “p” in the original recording. Similarly, the syllable “pA*” that is selected to synthesize the word PASTA pA*¦stx˜] must be selected from a class of “pA*” syllables that were originally followed by an “s”. That is, the original linguistic context for “pA*” must be considered when synthesizing it with other syllables.

Phonetic Symbol Set and Phrase List

As described above, the concatenative unit in embodiments of the TTS System of the present invention is the syllable-in-context. The TTS System stores in its TTS database every possible English syllable, and if the syllable is bounded by a vowel on at least one side, its possible linguistic context is encoded as well.

Before a recording list of phrases comprising every English syllable with its phonetic transcription could be created, a phonetic symbols set has to be selected for use. The Applicants have created unique phonetic symbols set. Most of prior phonetic transcription systems had problems, such as the use of multiple letters or non-alphabetic characters to represent a single sound and the failure to make certain important distinctions. For the purposes of embodiments of the TTS system of the present invention, the phonetic symbols set needed to be easy to process computationally, as well as easy for the voice talent to learn quickly and record the phrases accurately.

Therefore, all the phonetic symbols are single alphabetic characters and easy to process. One of the ramifications of having a syllable-in-context concatenative unit is that a fewer number of phonemes are required than in systems which base their concatenative unit on the phoneme or diphone. In embodiments of the TTS system of the present invention, only 39 phonemes were selected. For example, only one type of “t” phoneme was utilized since the varied linguistic context for “t” in words such as “tea” and “steep” will already be encoded as part of the syllable unit. prosodic symbols such as the four levels of stress are diacritic. The stress levels that are represented are the unstressed, the primary stress, the phrasal stress, and the secondary stress.

In some embodiments, with the phonetic symbols set created, a recording list of is produced. In at least one example of the present invention, 120,000 phrases were produced. In creating the phrase list, a special algorithm was utilized to encompass every possible English syllable within the smallest number of phrases. Once these phrases are recorded and analyzed into concatenative units, this expertly engineered phrase list enables the Applicant's TTS system to produce any English word because the phrase list includes every possible English syllable along with their linguistic context. Some examples of phrases and their phonetic transcriptions from the phrase list are the following:

```
CLARYVILLE COLLISION & CUSTOMS:
    kle′ri˜|vI″l]kx˜|lI′|Zx˜n]a˜nd]kx*|stx˜mz}
CLAIBORNE AT ESPLANADE SS:
    kle′|bc″rn]a˜t]E′|splx˜|nA″d]E′s]E*s}
CLAYLAND IGA FOODLINER:
    kle′|lx˜nd]Y′]Ji′]e′]fu*d|lY″|nR˜}
CLAYPIT HILL ELEMENTARY SCHOOL:
    kle′|pI″t]hI′l]E″|lx˜|mE*n|tx˜ri˜]sku′l}
```

Voice Recording

In embodiments of the present invention a voice talent uses a voice recording method to record the all the phrases in the phrase list. In embodiments where the TTS system is utilized to a navigation system, the phrases are selected from a map data file which includes all of street names and point of interest (POI) names throughout the country. The Applicants have employed a greedy algorithm for selecting the phrases. The greedy algorithm is an algorithm that always takes the best immediate, or local, solution while finding an answer. Greedy algorithms find the overall, or globally, optimal solution for some optimization problems, but may find less-than-optimal solutions for some instances of other problems. If there is no greedy algorithm that always finds the optimal solution for a problem, a user may have to search (exponentially) many possible solutions to find the optimum. Greedy algorithms are usually quicker, since they don't consider the details of possible alternatives. In embodiments, the system may use a map data file such as one commercially available through a provider, for example, NAVTECH, Inc. of Monterey, Calif., USA.

The invention in embodiments can include a recording tool which displays each phrase one phrase at a time. As each phrase is recorded and saved, the recording tool automatically advances to the next phrase. The recording tool minimizes recording time and errors by automatically validating the amplitude of the recorded speech. In this way, each phrase is assured of having a consistent range in amplitude.

The recording tool also ensures that the recorded speech is not cut off at the beginning or at the end of the spoken phrase. That is, the voice talent is not allowed to advance to the next phrase if the voice talent starts to speak before turning on the toggle switch of the recording tool. In embodiments the tool also automatically places a minimum number of milliseconds of silence at both the start and end of the phrase so that the phrase can be more easily split into concatenative units at a later stage.

As stated in the phrase list section above, the voice talent must learn the phonetic symbols set in order to pronounce the phrases accurately. The recording tool displays the phonetic symbols legend for quick reference. Furthermore, in order to maximize the accuracy of reading the phrases, only the phonetic transcription is displayed on the recording tool screen. The English text is hidden from view in order to avoid having ambiguous phrases read incorrectly. For example, “record” is pronounced differently depending on whether it's construed as a noun or a verb. Abbreviations such as “St.” and “Dr.” are also ambiguous.

Once the recording session starts, a phrase to be recorded will appear in the lower panel of a split window. The pronunciation guide of this phrase appears underneath. To start recording, the voice talent can select the menu item Record¦Begin, or click a button on the tool bar with the left button of your mouse, or simply press the Down Arrow on a keyboard. A red circle will appear in the upper panel indicating recording is in progress. When the voice talent finishes reading the phrase, she/he can select the menu item Record¦End, or click a button on the tool bar with the left button of your mouse, or simply press the Down Arrow again on your keyboard. The waveform of the recording will appear in the upper panel.

The voice talent needs to read the phrase with a clear, steady and natural voice. If the voice is too loud or too weak, the voice talent will be prompted to read again. If the recording is good, the voice talent can move on to the next phrase by selecting the menu item Phrase¦Next or clicking a button on the tool bar or simply pressing the Right Arrow on your keyboard. The recording will be automatically saved.

If it is necessary to hear a hint on the proper pronunciation of a phrase, the voice talent can select the menu item Phrase¦TTS or click a button on the tool bar or simply press the Up Arrow on your keyboard. To browse recorded phrases, the voice talent can select the menu item Phrase¦Previous or click a button on the tool bar or simply press the Left Arrow on your keyboard. The voice talent can select the menu item Phrase¦Next or click a button on the tool bar or press the Right Arrow on your keyboard to return to the end of the recorded phrase list. To listen to a recorded phrase, the voice talent can select the menu item Record¦Play or click the button on the tool bar.

Voice Analysis

Linguistic Algorithms

Embodiments of the present invention also include a method and apparatus for voice analysis. In at least one embodiment the Applicants have developed a voice analysis tool which provides an automatic syllable mark-up of all the recorded phrases. The voice analysis tool analyzes speech, one phrase at a time, by using complex linguistic algorithms to detect and mark the start and end of syllables and supersyllables which are the concatenative units. In order to create optimal mark-ups of the phrases, aside from using well known linguistic knowledge such as the second formant transition between consonants and vowels, the inventors have formulated the following algorithms for use within the voice analysis tool.

1. Unvoiced syllable-final regions in the speech waveforms of sonorants such as vowels, liquids, glides and nasals are omitted. Omitting such unvoiced regions saves storage space and provides for an optimal speech synthesis rate. (Phrase-final syllable endings are left intact.)

2. Any pauses in between the words of a phrase are omitted. This omission saves storage space.

3. Creakiness is omitted in order to create a smoother speech output. The unvoiced closure of stops are omitted in the mark-ups. At speech synthesis runtime, silent headers for the stops are manufactured. This omission during mark-up of the phrases also saves storage space.

4. The use of Reflection Coefficient calculations instead of Formant calculations to determine transitional boundaries between voiced and unvoiced regions. These are much easier to compute than Formants, while yielding more information. Accurately defining the onset, and end of “true voicing” is crucial to the determination of syllable boundaries.

5. Accurate detection of: frication, pitch, RMS Energy, stop bursts, and silence.

6. Detecting a small but significant drop in voicing within a voiced region.

7. Detection of vowels within a long sequencing of voicing, including any minimal power regions separating them.

8. Finding a region of minimal power embedded within a larger region.

9. Nasal detection using Reflection Coefficient info as well as power stats.

10. The blotting out of low-energy transitional information between the end of a syllable and the start of the next one. This makes each syllable more sharable in other contexts.

The voice analysis tool also has a concatenation mode in which the marked-up syllables can be concatenated to demonstrate their accuracy. (1) A “Narrate” feature was instated into the tool which allows the consecutive concatenation of phrases instead of having them read out one by one. (2) During the Narrate mode, a feature that allows pressing a button to automatically place incorrect concatenations into a text file was installed. This saves time by not having to stop the concatenation process and manually write down the errors.

Instead of using the mouse to zoom in on certain parts of the phrase during mark-up, a zoom button was installed which allows zooming out several times for easy review of the intricate speech waveforms. A separate button allows zooming back in. Using zoom buttons instead of the. mouse saves wear and tear on the wrist since thousands of phrases must be reviewed.

An example is a case where syllables in a phrase “MirrorLight Place” are marked-up. In this example, the syllable corresponds to “Mirror” is a supersyllable noted above.

A voice waveform can be shown that is a combination of various frequency components (fundamental and harmonics) and their amplitudes that change depending on the tone, stress, and type of the voice, etc. A pitch plot shows changes of fundamental frequency. If the phrase is spoken by the same tone (frequency), the plot will be flat in a horizontal direction. If the plot goes higher, it means that the tone (frequency) of the recorded voice becomes higher. The reflection coefficients f2 and f3 help to find a boundary between two syllables. In this example, although the reflection coefficient f2 does not show any significant change between the syllables corresponding to “Mirror” and “Light”, the reflection coefficient f3 shows a sharp change between the syllables, which signifies the syllable boundary.

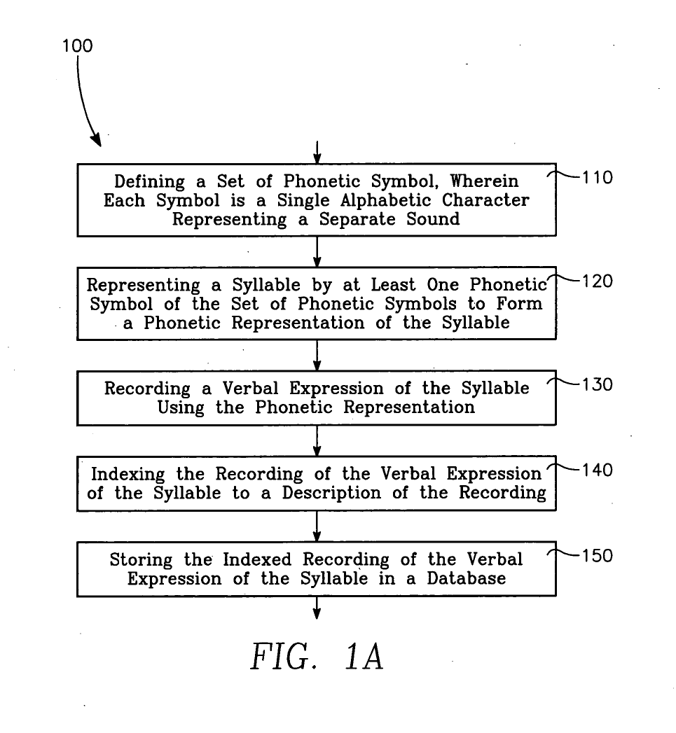

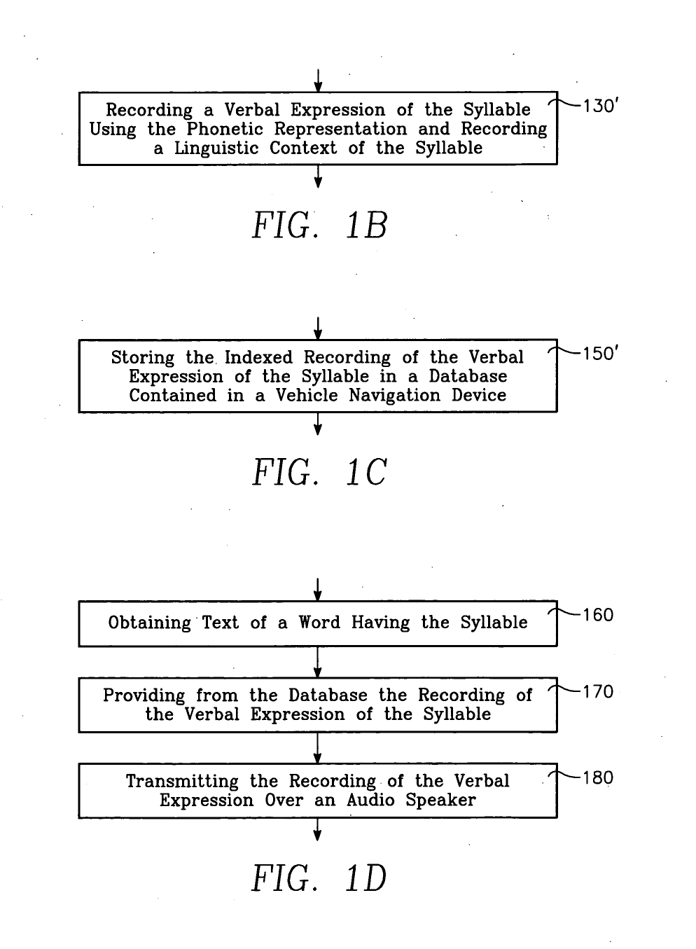

In embodiments the present invention is a method 100 as shown in FIG. 1A. As shown, the method 100 includes the steps of defining a set of phonetic symbols, wherein each symbol is a single alphabetic character representing a separate sound 110, representing a syllable by at least one phonetic symbol of the set of phonetic symbols to form a phonetic representation of the syllable 120, recording a verbal expression of the syllable using the phonetic representation 130, indexing the recording of the verbal expression of the syllable to a description of the recording 140 and storing the indexed recording of the verbal expression of the syllable in a database 150. Of course, in other embodiments the steps and their order can be different from the embodiment shown in FIG. 1A.

As shown, the first step of the method 100 is defining a set of phonetic symbols, wherein each symbol is a single alphabetic character representing a separate sound 110. In this step a set of single alphabetic phonetic symbols are created to aid in the voice talent or speaker to pronounce a given syllable, word phrase or the like. Each phonetic symbol represents a sound which can be made in the particular language the system is using. While the symbols tend to relate to the sound that they each represent, it may be required that the voice talent become accustomed (memorize) the relation between the symbol and the sound associated with the symbol.

It should be noted that the Applicants have found that using a single alphabetic character to represent the sound, provides improve result from the voice talent. Namely, the voice talents tend to be able to make the association with the character and the sound it represents quicker and they tend to have less confusion when reading a series of single alphabetic character symbols and pronouncing the related sounds.

An example of a set of single alphabetic character phonetic symbols is shown in table A below:

TABLE A

| Description | Character | Example |
|---|---|---|
| vl lab asp | p | pee speed |
| vd lab stp | b | Be |
| vl alv stp | t | t‘ea steep letter kitten |
| vd alv stp | d | Dee |
| vl vlr stp | k | key ski |
| vd vlr stp | g | McGee |
| vl alv aff | C | Cheap |
| vd alv aff | J | Jeep |
| vl lab frc | f | Fee |
| vd lab frc | v | Vee |
| vl dnt frc | Q | Theme |
| vd dnt frc | D | Thee |
| vl alv frc | s | Sea |
| vd alv frc | z | zee |
| vl plt frc | S | she |
| vd plt frc | Z | Asia |
| vl glt frc | h | he |
| vd lab nsl | m | me |
| vd alv nsl | n | nee |
| vd vlr nsl | G | ping |
| vd alv rtr | r | read |
| vd alv lat | l | lee |
| vd plt apr | y | yee |
| vd lab apr | w | we |
| fr hi ur ts | i | eat |
| fr hi ur lx | I | hit it |
| fr md ur ts | e | ate |
| fr md ur lx | E | Ed |
| fr lo ur lx | a | at |
| bk lo ur lx | A | odd |
| bk md rd ts | o | oat |
| bk md rd lx | c | ought |
| bk md ur lx | x | hut but |
| bk hi rd ts | u | food |
| bk hi rd lx | U | foot |
| bf lo to hi | Y | hide |
| bf md to hi | O | voit |
| bk lo to hi | W | out |
| bk md rtr | R | hurt butter |
| prim strs | ’ | |
| scnd strs | ” | |
| phrs strs | * | |
| no strs | ˜ | |
| syll bndry | \| | |
| word bndry | ] | |
| phrs bndry | } | |

A glossary of the description terms in Table A are provided below in Table B:

TABLE B

| | |
|---|---|
| aff | affricate |
| alv | alveolar |
| apr | approximant |
| asp | aspirated |
| bk | back |
| bndry | boundary |
| dnt | dental |
| flp | flap |
| fr | front |
| frc | fricative |
| glt | glottal |
| hi | high |
| lab | labial |
| lat | lateral |
| lo | low |
| lx | lax |
| md | mid |
| nsl | nasal |
| phrs | phrase |
| plt | palatal |
| prim | primary |
| rd | round |
| rtr | retroflex |
| scnd | secondary |
| stp | stop |
| strs | stress |
| syl | syllabic |
| syll | syllable |
| ts | tense |
| ur | unrounded |
| vd | voiced |
| vl | voiceless |
| vlr | vela |

As can be seen in Table A, in this embodiment the total number of characters in the set is just 39. The relatively low number of characters also aid the voice talent as the amount of memorization needed is reduce, resulting in increased accuracy and reduced time required to complete the project. Also shown in Table A is that in addition to the 39 character there is included several characters representing stresses.

The next step of method 100 is representing a syllable by at least one phonetic symbol of the set of phonetic symbols to form a phonetic representation of the syllable 120. During this step one or more phonetic symbols are used to represent the syllable. That is the sounds that the phonetic symbols represent should match the overall sound of the particular syllable. Typically, a syllable will be represented by several phonetic symbols and a set of syllables of a word will be represented by a series of phonetic symbols. One of the advantages of having the syllable-in-context concatenative unit as with the present invention, is that a fewer number of phonemes are required than in systems which base their concatenative unit on the phoneme or diphone.

The next step of the method 100 is recording a verbal expression of the syllable using the phonetic representation 130. During this step the voice talent will typically read from a display of a set of phonetic characters (the phonetic representation) which represent a syllable, word or phrase and speak or pronounce the particular syllable, word or phrase. While the voice talent is speaking a recording is made for eventual storage in a database. The Applicants have found that use of the phonetic representation by the voice talent, instead of simply a textual description, to make the pronunciation of the syllable reduces the number of errors made by the voice talent. Of course reducing the number of errors then reduces the time and cost to compile the database.

As noted above in detail, the present invention also allows the recordation of the syllable in its linguistic context. The linguistic context can include what bounds the syllable, such as either a vowel or a consonant. Including the linguistic is import to increasing the quality of the later speech synthesis as the context directly affects how the syllable is pronounced.

As such, as shown in FIG. 1B, in embodiments of the invention, the step 130 can instead be recording a verbal expression of the syllable using the phonetic representation and recording a linguistic context of the syllable 130′.

Returning to FIG. 1A, the next step of the method 100 is indexing the recording of the verbal expression of the syllable to a description of the recording 140. This step allow for later retrieval of the verbal recording from the database. As noted in detail below, such a process could include starting with text of a word that the user was to synthesize speech for, obtaining from the database, through the indexing of the present step, a verbal recording of the syllable (in context or not), and transmitting the recording over an audio speaker.

The final step of the method 100 as shown in FIG. 1A is storing the indexed recording of the verbal expression of the syllable in a database 150. Of course storing of the recording is important as allows that recording to be used over and over again. Once all the syllables (with context in some embodiments) are stored in a database, then the system can reproduce any word in that language.

As shown in FIG. 1C, in some embodiments, the database where the recording the is stored is contained in a vehicle navigation device. The step 150 is set forth as an alternative embodiment of storing the indexed recording in a database contained in a vehicle navigation device 150′.

FIG. 1D sets forth additional steps which in some embodiments, can be added to the method 100. Namely these steps include obtaining text of a word having the syllable 160, providing from the database the recording of the verbal expression of the syllable 170, and transmitting the recording of the verbal expression over an audio speaker 180.

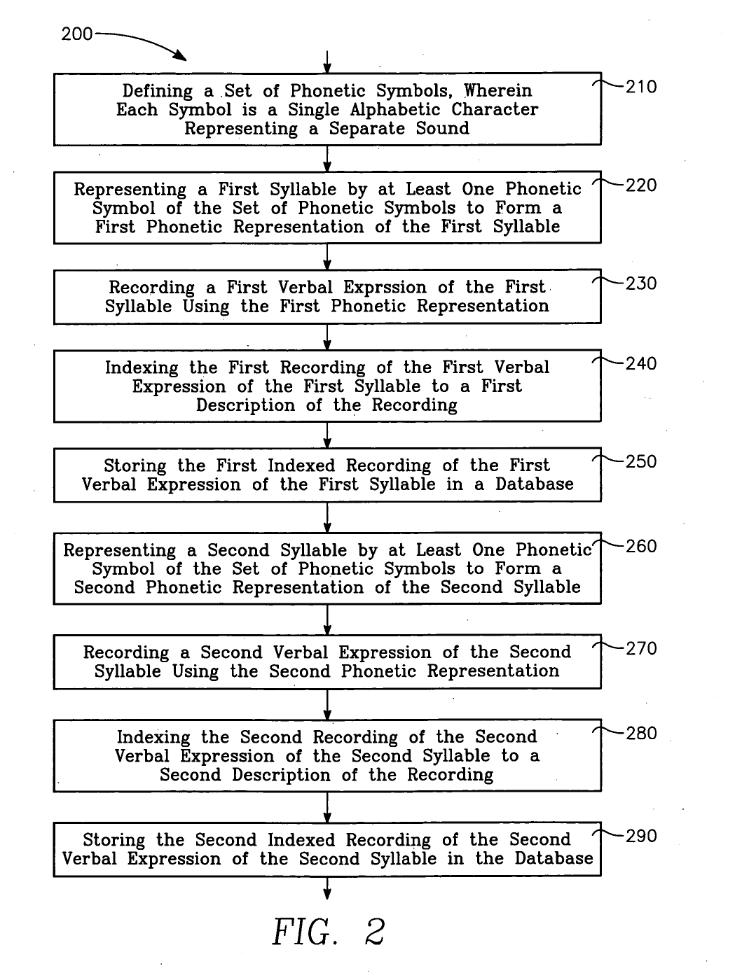

FIG. 2 shows another embodiment of the method of the present invention. Specifically, the method 200 includes the steps of defining a set of phonetic symbols, wherein each symbol is a single alphabetic character representing a separate sound 210, representing a first syllable by at least one phonetic symbol of the set of phonetic symbols to form a first phonetic representation of the first syllable 220, recording a first verbal expression of the first syllable using the first phonetic representation 230, indexing the first recording of the first verbal expression of the first syllable to a first description of the recording 240, storing the first indexed recording of the first verbal expression of the first syllable in a database 250, representing a second syllable by at least one phonetic symbol of the set of phonetic symbols to form a second phonetic representation of the syllable 260, recording a second verbal expression of the second syllable using the second phonetic representation 270, indexing the second recording of the second verbal expression of the second syllable to a second description of the recording 280, and storing the second indexed recording of the second verbal expression of the second syllable in a database 290.

The method 200 differs from the method 100 in part as it includes both a first syllable and a second syllable. The method 200 includes situations when multiple syllable word are being utilized by the method.

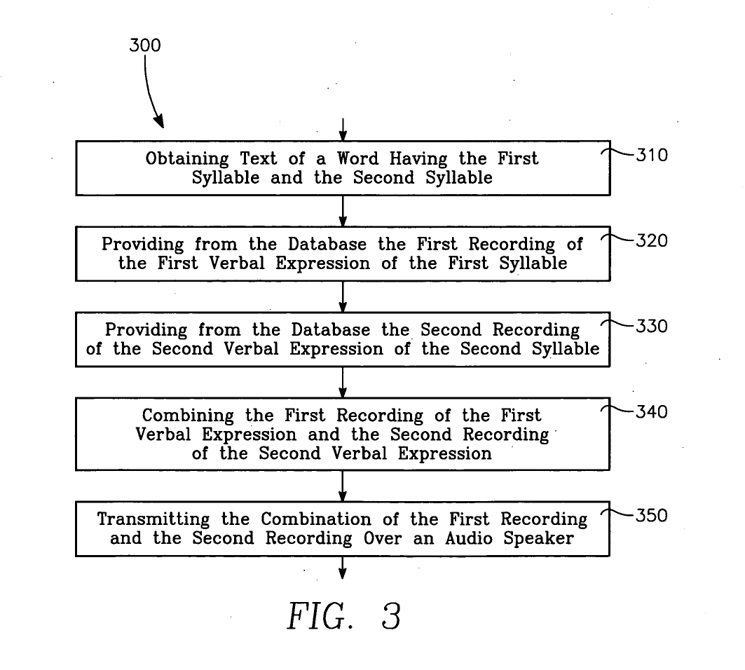

The method 300 shown in FIG. 3 sets forth additional steps which can, in embodiments, be carried out after the steps of the method 200. Method 300 includes the steps of obtaining text of a word having the first syllable and the second syllable 310, providing from the database the first recording of the first verbal expression of the first syllable 320, providing from the database the second recording of the second verbal expression of the second syllable 330, combining the first recording of the first verbal expression and the second recording of the second verbal expression 340, and transmitting the combination of the first recording and the second recording over an audio speaker 350.

Although this invention has been disclosed in the context of certain embodiments and examples, it will be understood by those or ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Furthermore, the processes described herein may be embodied in hardware, in a set of program instructions-software, or both, i.e., firmware. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A method for populating a text to speech synthesis database comprising:
defining a set of phonetic symbols, wherein each symbol is a single alphabetic character representing a separate sound;
representing a syllable by at least one phonetic symbol of the set of phonetic symbols to form a phonetic representation of the syllable;
recording a verbal expression of the syllable using the phonetic representation;
indexing the recording of the verbal expression of the syllable to a description of the recording; and
storing the indexed recording of the verbal expression of the syllable in a database.

2. The method for populating a text to speech synthesis database of claim 1, wherein the set of phonetic symbols comprises less than 50 symbols.

3. The method for populating a text to speech synthesis database of claim 2, wherein the set of phonetic symbols comprises 39 symbols.

4. The method for populating a text to speech synthesis database of claim 1, wherein the phonetic representation of the syllable comprises at least two phonetic symbols.

5. The method for populating a text to speech synthesis database of claim 1, wherein the set of phonetic symbols comprises at least one symbol indicating a level of stress.

6. The method for populating a text to speech synthesis database of claim 5, wherein the set of phonetic symbols comprises four symbols indicating levels of stress.

7. The method for populating a text to speech synthesis database of claim 6, wherein the four symbols indicating levels of stress include an unstressed symbol, a primary stress symbol, a phrasal stress symbol, and a secondary stress symbol.

8. The method for populating a text to speech synthesis database of claim 1, wherein each sound represented by an alphabetic character of the symbol set is a single phoneme.

9. The method for populating a text to speech synthesis database of claim 1, wherein recording a verbal expression of the syllable using the phonetic representation further comprises recording a linguistic context of the syllable.

10. The method for populating a text to speech synthesis database of claim 9, wherein the linguistic context of the syllable defines whether the syllable is bounded by a vowel.

11. The method for populating a text to speech synthesis database of claim 9, wherein the description of the recording further comprises the linguistic context of the syllable.

12. The method for populating a text to speech synthesis database of claim 1, wherein storing the indexed recording of the verbal expression of the syllable in a database further comprises storing the indexed recording in a database contained in a vehicle navigation device.

13. The method for populating a text to speech synthesis database of claim 1, further comprising:
obtaining text of a word having the syllable;
providing from the database the recording of the verbal expression of the syllable; and
transmitting the recording of the verbal expression over an audio speaker.

14. A method for populating a text to speech synthesis database comprising:
defining a set of phonetic symbols, wherein each symbol is a single alphabetic character representing a separate sound;
representing a first syllable by at least one phonetic symbol of the set of phonetic symbols to form a first phonetic representation of the first syllable;
recording a first verbal expression of the first syllable using the first phonetic representation;
indexing the first recording of the first verbal expression of the first syllable to a first description of the recording;
storing the first indexed recording of the first verbal expression of the first syllable in a database;
representing a second syllable by at least one phonetic symbol of the set of phonetic symbols to form a second phonetic representation of the syllable;
recording a second verbal expression of the second syllable using the second phonetic representation;
indexing the second recording of the second verbal expression of the second syllable to a second description of the recording; and
storing the second indexed recording of the second verbal expression of the second syllable in a database.

15. The method for populating a text to speech synthesis database of claim 14, further comprising:
obtaining text of a word having the first syllable and the second syllable;
providing from the database the first recording of the first verbal expression of the first syllable;
providing from the database the second recording of the second verbal expression of the second syllable;
combining the first recording of the first verbal expression and the second recording of the second verbal expression; and
transmitting the combination of the first recording and the second recording over an audio speaker.
